(19) United States
(12) Patent Application Publication
(10) Pub. No.: US 2012/0249075 A1
(43) Pub. Date: Oct. 4, 2012

(54) SECONDARY BATTERY VOLTAGE DETECTING SYSTEM

(75) Inventors: Yuki Hori, Sagamihara-shi (JP); Shin Suzuki, Sagamihara-shi (JP)

(73) Assignee: NEC ENERGY DEVICES, LTD., Sagamihara-shi, Kanagawa (JP)

(21) Appl. No.: 13/517,201

(22) PCT Filed: Oct. 14, 2010
(86) PCT No.: PCT/JP2010/068055

§ 371 Date: Jun. 19, 2012

(30) Foreign Application Priority Data
Dec. 24, 2009 (JP) 2009-292854

(51) Int. Cl. H02J 7/00

(52) U.S. Cl. 320/118

(57) ABSTRACT

A secondary battery voltage detecting system includes: a battery group in which lithium ion secondary batteries are connected in series; a charging and discharging switch that is connected between the battery group and an output terminal and performs charging and discharging; abnormality detectors that divide the batteries of the battery group into blocks and that detect battery voltages; a CPU that performs arithmetic processing of respective detection signals of protection elements including the abnormality detectors; first voltage level converters that make voltage references of the detection signals uniform between the protection elements and the CPU; and second voltage level converters connected between the abnormality detectors and the first voltage level converters. The CPU outputs, at a time interval set in advance, a signal for causing the second voltage level converters to operate and electrically isolates or connects paths between the detectors and the first voltage level converters.

### TECHNICAL FIELD

The present invention relates to a secondary battery voltage detecting system that detects the voltage of a multi-series lithium ion secondary battery in a battery pack of lithium ion secondary batteries.

### BACKGROUND ART

A secondary battery such as a lithium ion secondary battery performs both input and output of energy between the secondary battery and the outside. Therefore, it is likely that overcharge, over-discharge, and the like occur depending on usage. These incidents may adversely affect the secondary battery involve dangers. Therefore, in general, a protection circuit is mounted on a secondary battery or the like to monitor the state of the battery.

Abnormalities such as overcharge and over-discharge of the battery in the protection circuit are detected by an abnormality detector including a cell protection IC and the like. There are roughly two types of cell protection ICs mounted on an abnormality detector.

One is a cell protection IC of a type that includes a serial communication function, communicates information such as the voltage and the electric current of cells included in a battery pack between the cell protection IC and a CPU mounted with a protection circuit, changes the voltage level of an operation terminal of the abnormality detector on the basis of the result of the communication, and performs isolation, connection, and the like of a switch provided on the charging and discharging circuit. As an example in which the cell protection IC including the serial communication function is used, there is a technique described in Patent Literature 1.

The other is a cell protection IC of a type that does not include the serial communication function, independently operates according to the presence or absence of abnormality of the cells, changes the voltage level of the operation terminal of the abnormality detector, and performs isolation and connection of the charging and discharging switch provided on the circuit. Both types of cell protection ICs perform isolation, connection, and the like of the charging and discharging switch provided on the circuit according to a change in the voltage level of the operation terminal. As an example in which such a configuration is used, there is a technique described in Patent Literature 2.

FIG. 1 is a block diagram showing an example of the configuration of a lithium ion secondary battery pack not including the serial communication function and including an abnormality detecting function.

In the secondary battery pack shown in FIG. 1, protection circuit 2 includes a protection function for detecting at least one kind of abnormality from among overcharge, over-discharge, over-current, and overheating of lithium ion secondary battery 1 and for performing, on the basis of the result of the detection, control of isolation, connection, and the like of charging and discharging switch 8 according to outputs from operation terminals 9 to 12 of abnormality detectors 3 to 6.

When the abnormality detecting method by abnormality detectors 3 to 6 including the above-mentioned protection ICs is applied to lithium ion secondary battery 1 including a large number of cells that are connected in series, the number of batteries that can be managed per one abnormality detector depends on the performance of the protection ICs in use. Therefore, to increase the number of series and apply general-purpose protection ICs to abnormality detection of lithium ion secondary battery 1, abnormality detectors 3 to 6 including the cell protection ICs also need to be configured in series.

FIG. 2 is a block diagram showing an abnormality detecting system of a multi-series battery back in the past.

As shown in FIG. 2, when the number of series of abnormality detectors 3 to 6 increases, 3 0 voltage levels of operation terminals 9 to 12 of respective abnormality detectors 3 to 6 become substantially different from each other. For example, in a circuit in which ten cells that make up lithium ion secondary battery 1 are connected in series, the voltages of operation terminals 9 to 12 of abnormality detectors 3 to 6 exceed 40 V at the maximum. In general, a device such as an FET is often used in charging and discharging switch 8. The range of a driving voltage is considered to be about 5 to 30 V and substantially deviates from a voltage level for enabling driving of charging and discharging switch 8 on the circuit. Therefore, it is difficult to directly drive charging and discharging switch 8 in the circuit according to the outputs of operation terminals 9 to 12 of abnormality detectors 3 to 6.

As a solution to the problem, CPU 7 is set in the circuit and voltage level converters A13 to A16 uniformly convert the voltage levels of operation terminals 9 to 12 of respective abnormality detectors 3 to 6, i.e., voltage references of detection signals in abnormality detectors 3 to 6 are converted into a voltage level readable by CPU 7 and then use abnormality detection terminal 17 of CPU 7 to read the voltage level. CPU 7 determines, on the basis of the voltage level read by abnormality detection terminal 17, in presence or absence of abnormality of the cells and controls charging and discharging switch 8 on the circuit with signal 18 from CPU 7.

### CITATION LIST

### Patent Literature

Patent Literature 1: JP2008-131670A

Patent Literature 2: JP2004-134372A

### SUMMARY OF INVENTION

### Technical Problem

However, the system shown in FIG. 2 has problems explained below.

Usually, it is important to prevent deterioration of a battery in order to maintain safety. Depending on logics of protection ICs during normal time and during abnormal time, because of the configuration of the circuit, voltage level converters A13 to A16 are in an operation state in which an electric current always flows. Therefore, the current that is used by voltage level converters A13 to A16 substantially increases the amount of current that used by protection circuit 2. For example, there is an over-discharge detecting function as a function that often shows such an operation logic in the operation of protection ICs. Protection ICs that are set to always monitor an abnormal signal indicating over-discharge from a battery and that, after detecting the abnormal signal, stop discharge from the battery, are often selected.

The operation of the system shown in FIG. 2 is specifically explained below.

FIG. 3 is a timing chart of signals in the system shown in FIG. 2.

The exchange of signals with CPU 7 in the range of abnormality detector 3, operation terminal 9, and voltage level converter A13, rather than in the entire circuit, is explained here. In the following explanation, the same applies to the exchange of signals with CPU 7 in the ranges of abnormality detector 4, operation terminal 10, and voltage level converter A14 and the subsequent abnormality detectors, operation terminals, and voltage level converters. In this case, a photo-coupler or the like is used in voltage level converter A13. The number of cells that are connected in series in lithium ion secondary battery 1 is represented as K (if a unit cell: Vb (V), K×Vb (V)). It is assumed that abnormality detector 3 monitors three cells of lithium ion secondary battery 1 (the unit cell: Vb (V), 3×Vb (V)). A signal voltage at abnormality detection terminal 17 determined as abnormal by CPU 7 is represented as CPU_Vcc (V) and a signal voltage at abnormality detection terminal 17 determined as normal by CPU 7 is represented as 0 (V).

First, the operation performed by the system when the voltages of the respective cells of lithium ion secondary battery 1 are normal is explained.

When the voltages of the respective cells of lithium ion secondary battery 1 are normal, a signal (K−3)×Vb (V) of a GND level of abnormality detector 3 is output as a normal signal from operation terminal 9 of abnormality detector 3.

Then, an LED of the photo-coupler of voltage level converter A13 emits light and a so-called photocurrent flows to a phototransistor. Therefore, the voltage at an output terminal of voltage level converter A13 drops from CPU_Vcc (V) to GND and a signal voltage 0 (V) is output to abnormality detection terminal 17. Consequently, CPU 7 determines that the voltages of the respective cells of lithium ion secondary battery 1 are in a normal state.

At this point, the value of the current value flowing to voltage level converter A13 to cause the LED to emit light is 3Vb/R1 (A). Since the reliability and the like of the lithium ion secondary battery are also improved, usually, the voltages of the respective cells of lithium ion secondary battery 1 continue to be normal for a long period. Therefore, if the normal state of the voltages of the respective cells of lithium ion secondary battery 1 continues, the electric current for causing the LED to emit light, which is a main consumed current of voltage level converter A13, continues to flow.

Subsequently, the operation performed by the system when an abnormality occurs in the voltages of the respective cells of lithium ion secondary battery 1 is explained.

When an abnormality occurs in the voltages of the respective cells of lithium ion secondary battery 1, abnormality detector 3 detects the abnormality. Then, a signal K×Vb (V) that indicates the power supply level of abnormality detector 3 is output as an abnormal signal from operation terminal 9 of abnormality detector 3.

In this case, the input voltage supplied to voltage level converter A13 is also K×Vb (V). Therefore, the potential difference in voltage level converter A13 disappears, the LED of the photo-coupler does not emit light, and the photocurrent does not flow to the phototransistor. Therefore, the signal voltage CPU_Vcc (V) is directly output from the output terminal of voltage level converter A13 to abnormality detection terminal 17. CPU 7 determines that an abnormality occurs in the cells of lithium ion secondary battery 1, causes charging and discharging switch 8 to operate, and is thus able to prevent a dangerous situation from occurring.

The electric current for causing the LED of voltage level converter A to emit light is required to be in a milliampere order. Therefore, a consumed current substantially increases. In recent years, in order to extend operating time in industrial equipment and to extend the traveling distance of electrically powered bicycles and hybrid automobiles, testing must be performed in order to find a way to reduce the amount of current that is consumed by voltage level concert A in order to further reduce the amount of current that is consumed by the entire protection circuit.

It is an object of the present invention to provide a secondary battery voltage detecting system that can reduce the amount of current that is consumed.

### Solution to Problem

A voltage detecting system for a multi-series lithium ion secondary battery according to the present invention is a secondary battery voltage detecting system including: a battery group in which lithium ion secondary batteries are connected in series; a charging and discharging switch that is connected between the battery group and an output terminal and performs charging and discharging; abnormality detectors that divide the batteries of the battery group into blocks and detect battery voltages; a CPU that performs arithmetic processing of respective detection signals of protection elements including the abnormality detectors; and first voltage level converters that make voltage references of the detection signals uniform between the protection elements and the CPU.

The secondary battery voltage detecting system includes second voltage level converters connected between the abnormality detectors and the first voltage level converters.

The CPU outputs, at a time interval set in advance, a signal for causing the second voltage level converters to operate and electrically isolates or connects paths between the abnormality detectors and the first voltage level converters.

In this way, in a protection circuit for the lithium ion secondary battery including a large number of cells that are connected in series, the second voltage level converters are provided in the paths between the abnormality detectors, which divide the batteries of the battery group into blocks and which detect the battery voltages, and the first voltage level converters, which make the voltage references of the detection signals uniform between the protection elements including the abnormality detectors and the CPU that performs the arithmetic processing of the respective detection signals of the protection elements, to make it possible to connect and isolate, according to the signal from the CPU, the paths for performing abnormality detection of the batteries. Therefore, it is possible to optimize time when the signal for the abnormality detection of the secondary batteries is output and reduce the amount of current that is consumed.

### Advantageous Effects of Invention

As explained above, in the present invention, in the protection circuit for the lithium ion secondary battery including a large number of batteries that are connected in series, the second voltage level converters are provided in the paths between the abnormality detectors, which divide the batteries of the battery group into blocks and which detect the battery voltages, and the first voltage level converters, which make the voltage references of the detection signals uniform between the protection elements including the abnormality detectors and the CPU that performs the arithmetic processing of the respective detection signals of the protection elements, to make it possible to connect and isolate, according to the signal from the CPU, the paths for performing abnormality detection of the batteries. It is possible to set time when the signal for the abnormality detection of the secondary batteries is output smaller than time when the signal is not output and optimize the time to thereby reduce the amount of current that is consumed.

### BRIEF DESCRIPTION OF THE DRAWINGS

FIG. 1 is a block diagram showing an example of the configuration of a lithium ion secondary battery pack not including a serial communication function and including an abnormality detecting function.

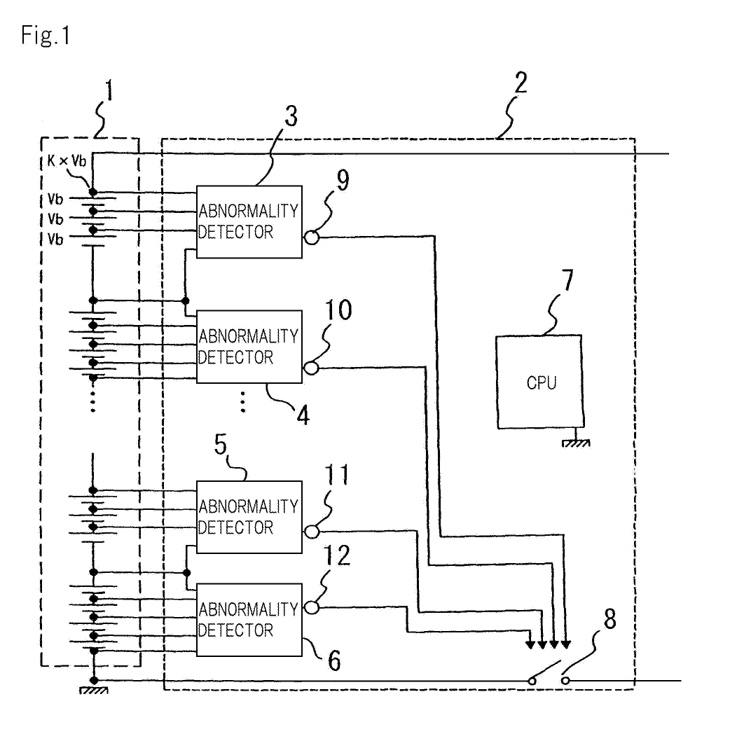

FIG. 2 is a block diagram showing an abnormality detecting system for a multi-series battery pack in the past.

FIG. 3 is a timing chart of signals in the system shown in FIG. 2.

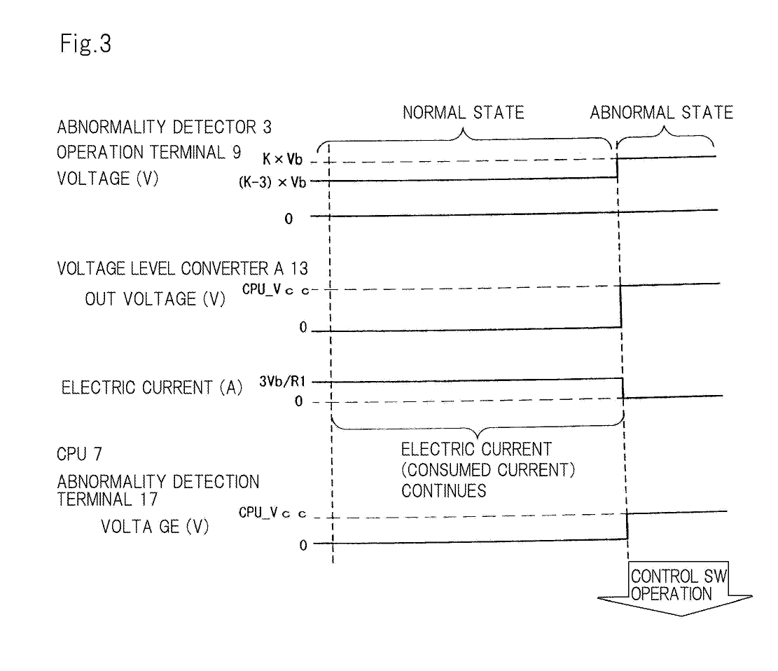

FIG. 4 is a block diagram showing an exemplary embodiment of a secondary battery voltage detecting system.

FIG. 5 is a timing chart of signals in the secondary battery voltage detecting system shown in FIG. 4.

### DESCRIPTION OF EMBODIMENT

An exemplary embodiment is explained below with reference to the drawings.

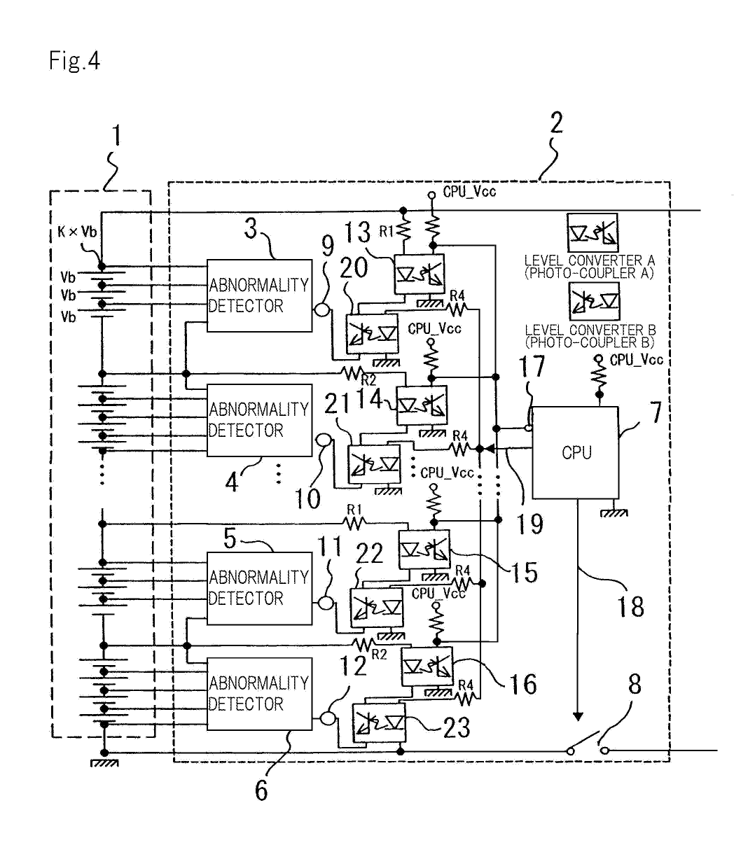

FIG. 4 is a block diagram showing an exemplary embodiment of a secondary battery voltage detecting system.

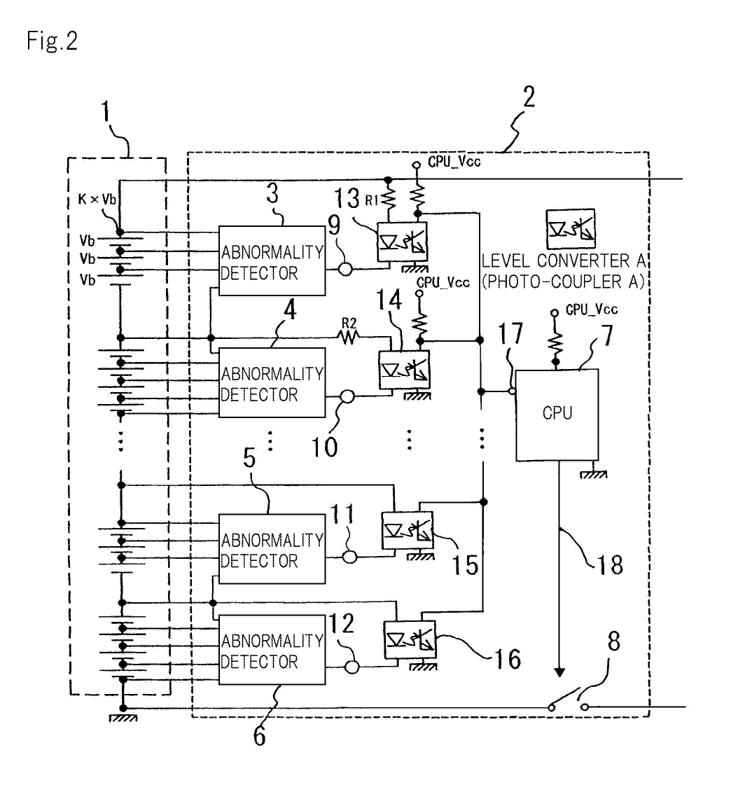

As shown in FIG. 4, this exemplary embodiment is substantially different from the abnormality detecting system shown in FIG. 2 in that second voltage level converters B20 to B23 are provided between abnormality detectors 3 to 6 and first voltage level converters A13 to A16, whereby it is possible to cause abnormality detectors 3 to 6 to monitor states of cells of a secondary battery at arbitrary time according to a signal of CPU 7 to reduce the amount of current that is always generated in a normal state.

As a circuit configuration, abnormality detectors 3 to 6 are set in protection circuit 2 of lithium ion lithium ion secondary battery 1 including a large number of cells that are connected in series. Voltage level converters B20 to B23 that isolate and connect paths between abnormality detectors 3 to 6 and voltage level converters A13 to A16 according to signal 19 from CPU 7 are set in paths between operation terminals 9 to 12 of abnormality detectors 3 to 6 and voltage level converters A13 to A16.

In some cases, terminals of protection ICs that functioning as protection elements directly function as operation terminals 9 to 12 of abnormality detectors 3 to 6 and, in other cases, when the absorbing ability of the protection ICs is insufficient, operation terminals 9 to 12 are present on the inside of a current amplifying circuit provided near the protection ICs.

The maximum voltage of lithium ion secondary battery 1 including a large number of batteries that are connected in series depends on the output of a lithium ion secondary battery in which cells of the lithium ion secondary battery are connected in series by the multiple of an integer. The voltage on the abnormality detector 3 side is higher than the voltage on the abnormality detector 6 side on a low voltage side.

As voltage level converters B20 to B23, it is desirable to use an element including a level converting function and a switch function such as a photo-coupler or an electromagnetic relay.

The operation of the secondary battery voltage detecting system configured as explained above is explained below.

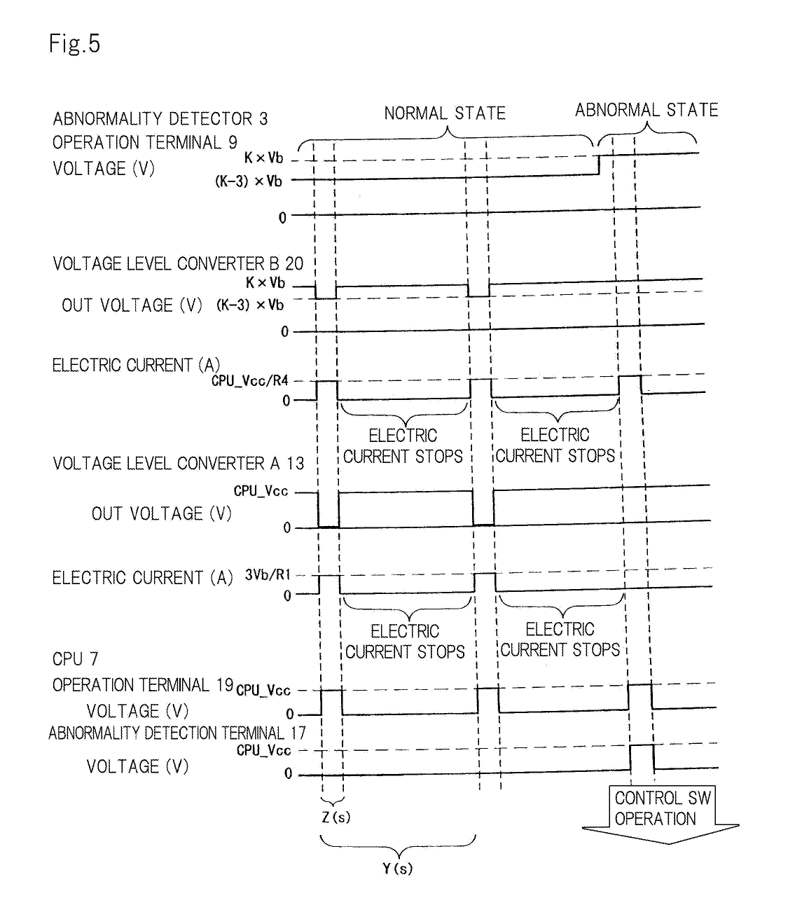

FIG. 5 is a timing chart of signals in the secondary battery voltage detecting system shown in FIG. 4.

The exchange of signals with CPU 7 in the range of abnormality detector 3, operation terminal 9, voltage level converter A13, and voltage level converter B20, rather than in the entire circuit, is explained here. In the following explanation, the same applies to the exchange of signals with CPU 7 in the ranges of abnormality detector 4, operation terminal 10, and voltage level converter A14 and the subsequent abnormality detectors, operation terminals, and voltage level converters. The number of cells that are connected in series in the secondary battery is represented as K (if a unit cell: Vb (V), K×Vb (V)). It is assumed that abnormality detector 3 monitors three cells (the unit cell: Vb (V), 3×Vb (V)). A signal voltage at abnormality detection terminal 17 determined as abnormal by CPU 7 is represented as CPU_Vcc (V) and a signal voltage at abnormality detection terminal 17 determined as normal by CPU 7 is represented as 0 (V).

First, the operation performed by the system when the voltages of the respective cells of lithium ion secondary battery 1 are normal is explained.

When the voltages of the respective cells of lithium ion secondary battery 1 are normal, a voltage signal detected by abnormality detector 3 is set to be (K−3)×Vb (V) as in the related art. Therefore, the signal voltage at operation terminal 9 is also (K−3)×Vb (V).

First, at an arbitrary duration, for example, Z (s) at a period interval for detection, signal voltage CPU_Vcc (V) serving as signal 19 for operating voltage level converter B20 is sent from CPU 7 to voltage level converter B20. Consequently, an LED of a photo-coupler of voltage level converter B20 emits light and the coupler changes to an ON state. According to this operation, states of the voltages of the respective cells of lithium ion secondary battery 1 are monitored from abnormality detector 9. At this point, the value of a current flowing to voltage level converter B20 that causes the LED to emit light is CPU_Vcc/R4 (A).

Subsequently, a photocurrent flows to voltage level converter B20, whereby the LED of voltage level converter A13 emits light and shines. CPU_Vcc drops to GND in association with the light emission and the signal voltage 0 (V) is output to abnormality detection terminal 17. Consequently, CPU 7 determines that the voltages of the respective cells of lithium ion secondary battery 1 are in a normal state.

At this point, the main amount of current that flows to voltage level converter Al 3 increases to a current value 3Vb/R1 (A) that causes the LED to emit light and to a current value CPU_Vcc/R4 (A) flowing to voltage level converter B20 that causes the LED to emit light.

In other words, in this exemplary embodiment, the amount of current that is consumed per unit time increases during abnormal detection because voltage level converter B20 is added. However, the system can be configured such that, when signal 19 is output from CPU 7, voltage level converter B20 operates, and the path between operation terminal 9 and voltage level converter A13 is electrically connected, and, otherwise, the path is electrically isolated. Therefore, the inefficient operation that continues to feed an electric current that causes the LED to emit light as long as the normal state of the voltages of the respective cells of lithium ion secondary battery 1 continues as in the system in the past explained above is eliminated.

While the path between operation terminal 9 and voltage level converter A13 is electrically isolated, operation terminal 9 is in an open state, information detected by abnormality detector 3 is not communicated to CPU 7, and abnormality detection terminal 17 detects CPU_Vcc. Therefore, in order to prevent a malfunction of CPU 7, abnormality detection terminal 17 is desirably set to insensitive. CPU 7 outputs signal 19 at arbitrary time set in advance or periodically to electrically connect the path between operation terminal 9 and voltage level converter A13. While the path is electrically connected, information detected by abnormality detector 3 is communicated to CPU 7. Therefore, abnormality detection terminal 17 releases the insensitivity setting.

Next, the operation performed by the system when an abnormality occurs in the voltages of the respective cells of lithium ion secondary battery 1 is explained.

When an abnormality occurs in the voltages of the respective cells of lithium ion secondary battery 1, as in the system in the past explained above, a voltage signal detected by abnormality detector 3 is set to be K×Vb (V). Therefore, the signal voltage at operation terminal 9 is also K×Vb (V).

Then, since an input voltage supplied to voltage level converter A13 is also K×Vb (V), the potential difference between voltage level converter A13 and voltage level converter B20 disappears. Consequently, voltage level converter B20 cannot operate and voltage level converter A13 also does not operate in association with the inoperability of voltage level converter B20. The signal voltage CPU_Vcc (V) is directly output to abnormality detection terminal 17. CPU 7 determines that an abnormality occurs in the cells of lithium ion secondary battery 1, causes charging and discharging switch 8 to operate, and is thus able to prevent a dangerous situation from occurring. At this point, except for the electric current that causes the LED of voltage level converter B20 to emit light, no current is consumed.

The effect of reducing the amount of current that is consumed by the secondary battery voltage detecting system according to this exemplary embodiment is explained below.

As in the system in the past explained above, the amount of current that is consumed by voltage level converters A13 to A16 is represented as X (A). The time of a period interval for detection is represented as Y (s). When the above-mentioned method of causing voltage level converters B20 to B23 to operate according to a signal from CPU 7 to electrically connect the paths between abnormality detectors 3 to 6 and voltage level converters A13 to A16 and limiting the operation of voltage level converters A13 to A16 is carried out, the amount of current that is consumed when voltage level converters A13 to A16 are set so that they will operate only in Z (s) of Y (s) and so that they will not operate in Y−Z (s) is Z/Y of X (A).

At this point, when the amount of current that is required for voltage level converters B20 to B23 is represented as K (A), the amount of current in this exemplary embodiment is Z/Y of (X+K) (A). Consequently, the system according to this exemplary embodiment can obtain a significant effect by setting Y and Z as Y>>Z.

The one exemplary embodiment is explained above. However, the present invention is not limited to this exemplary embodiment. Design changes in a range not departing from the spirit of the present invention are included in the present invention. In other words, various modifications and corrections apparent to those skilled in the art are also included in the present invention.

This application claims the benefit of priority from Japanese Patent Application No. 2009-292854 filed on Dec. 24, 2009, the entire disclosure of which is incorporated herein by reference.

1. A secondary battery voltage detecting system comprising: a battery group in which lithium ion secondary batteries are connected in series; a charging and discharging switch that is connected between said battery group and an output terminal and performs charging and discharging; abnormality detectors that divide the batteries of said battery group into blocks and detect battery voltages; a CPU that performs arithmetic processing of respective detection signals of protection elements including said abnormality detectors; and first voltage level converters that make voltage references of the detection signals uniform between the protection elements and said CPU, characterized in that
said secondary battery voltage detecting system includes second voltage level converters connected between said abnormality detectors and said first voltage level converters, and
said CPU outputs, at a time interval set in advance, a signal for causing said second voltage level converters to operate and electrically isolates or connects paths between said abnormality detectors and said first voltage level converters.
